(19) United States
(12) Patent Application Publication
(10) Pub. No.: US 2021/0067835 A1
(43) Pub. Date: Mar. 4, 2021

(54) BARKER MESSAGE SYSTEM

(71) Applicant: Sony Corporation, Tokyo (JP)

(72) Inventors: Brant Candelore, Poway, CA (US); Mahyar Nejat, La Jolla, CA (US); Scott Szabo, San Diego, CA (US)

(73) Assignee: Sony Corporation, Tokyo (JP)

(21) Appl. No.: 16/560,903

(22) Filed: Sep. 4, 2019

(51) Int. Cl. H04N 21/488; H04N 21/422; H04N 21/81; H04N 21/485; H04N 21/431

(52) U.S. Cl. CPC H04N 21/4882; H04N 21/42204; H04N 21/4312; H04N 21/485; H04N 21/812

(57) ABSTRACT

Implementations generally relate to a message system. In some implementations, a method includes detecting a selection of a button on a user interface associated with a television platform. The method further includes executing at least one predetermined function associated with the button. The method further includes providing a message on the television platform based on one or more predetermined policies.

### BACKGROUND

Many television platforms such as standalone smart-televisions, set-top boxes from cable, satellite or telco operators, and HDMI modules may utilize tablets and mobile devices for selecting and viewing media content such as movies and television shows. Such platforms display a user interface with icons of menus, features, services and applications. Placing an icon of a promotion program with other icons in the user interface generally has limited effect as the icon may not be easy to find and users are sometimes hesitant to click on promotion icons. Users also dislike listening to traditional advertising or infomercials.

### SUMMARY

Implementations generally relate to a message. In some implementations, a system includes one or more processors, and includes logic encoded in one or more non-transitory computer-readable storage media for execution by the one or more processors. When executed, the logic is operable to cause the one or more processors to perform operations including: detecting a selection of a button on a user interface associated with a television platform; executing at least one predetermined function associated with the button; and providing a message on the television platform based on one or more predetermined policies.

With further regard to the system, in some implementations, the button is one of a plurality of buttons on the user interface, and the plurality of buttons are associated with a plurality of predetermined functions. In some implementations, the providing of the message is based at least in part on a configuration file. In some implementations, the message includes an announcement of one of a new feature or information for an existing feature. In some implementations, the message includes an advertisement for at least one of a service or a show. In some implementations, the message includes one or more of text, audio, and video. In some implementations, the logic when executed is further operable to cause the one or more processors to perform operations including providing the message based at least in part on a predetermined time interval or a predetermined button selection count.

In some embodiments, a non-transitory computer-readable storage medium with program instructions thereon is provided. When executed by one or more processors, the instructions are operable to cause the one or more processors to perform operations including: detecting a selection of a button on a user interface associated with a television platform; executing at least one predetermined function associated with the button; and providing a message on the television platform based on one or more predetermined policies.

With further regard to the computer-readable storage medium, in some implementations, the button is one of a plurality of buttons on the user interface, and the plurality of buttons are associated with a plurality of predetermined functions. In some implementations, the providing of the message is based at least in part on a configuration file. In some implementations, the message includes an announcement of one of a new feature or information for an existing feature. In some implementations, the message includes an advertisement for at least one of a service or a show. In some implementations, the message includes one or more of text, audio, and video. In some implementations, the instructions when executed are further operable to cause the one or more processors to perform operations including providing the message based at least in part on a predetermined time interval or a predetermined button selection count.

In some implementations, a method includes: detecting a selection of a button on a user interface associated with a television platform; executing at least one predetermined function associated with the button; and providing a message on the television platform based on one or more predetermined policies.

With further regard to the method, in some implementations, the button is one of a plurality of buttons on the user interface, and where the plurality of buttons are associated with a plurality of predetermined functions. In some implementations, the providing of the message is based at least in part on a configuration file. In some implementations, the message includes an announcement of one of a new feature or information for an existing feature. In some implementations, the message includes an advertisement for at least one of a service or a show. In some implementations, the message includes one or more of text, audio, and video.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example media environment, which may be used for some implementations described herein.

FIG. 2 is an example flow diagram for providing messages on a television platform, according to some implementations.

FIG. 3 is a block diagram of an example remote control device, according to some implementations.

FIG. 4 is a block diagram of an example network environment, which may be used for some implementations described herein.

FIG. 5 is a block diagram of an example computer system, which may be used for some implementations described herein.

### DETAILED DESCRIPTION

Implementations described herein related to a message system. As described in more detail herein, implementations enable a user to learn about aspects, features, and products associated with his or her television platform. Implementations provide an innocuous message system that does not require the user to specifically activate it and that is triggered in such a way as to not annoy the user. The messages may consist of graphics, text, audio, and video, or combination thereof. As described in detail herein, the television platform may be a standalone television, but may also be a set-top from a cable, satellite or telco service provider, depending on the particular implementation. The television platform may also be an over-the-top (OTT) device that aggregates content that connects to the television over HDMI. All such devices may be deemed equivalent. Messages are presented to the user in a subtle and non-obtrusive way.

As described in more detail herein, in various implementations, a system detects a selection of a button on a user interface associated with a television platform. The system then executes at least one predetermined function associated with the button. The system then provides a message on the television platform based on one or more predetermined policies. Such messaging may include messages alerting the user to new and existing features of the TV platform, promotional programs, streaming services, etc.

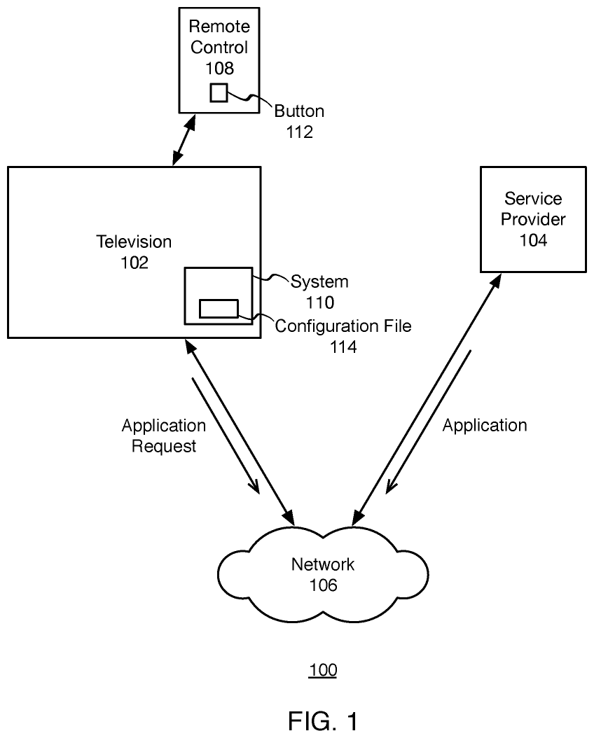

FIG. 1 illustrates a block diagram of an example media environment 100, which may be used for some implementations described herein. In some implementations, media environment 100 includes a television platform, e.g., standalone television 102 and a service provider 104, which may communicate with each other via a network 106. In some implementations, the network may be the Internet. In some implementations, the network may include any combination of networks such as the Internet, a wide area network (WAN), a local area network (LAN), a Wi-Fi network, a Bluetooth network, near-field communication (NFC) network, cable network, etc.

In various implementations, a user may use a remote control 108 to communicate with a system 110 associated with television 102. The terms remote control, remote control device, and remote may be used interchangeably. Remote control 108 includes various control buttons such as button 112. For ease of illustration, one button 112 is shown. There may be any number of control buttons on remote control 108. The remote control 108 is shown in this particular example. In other embodiments, there may be an on-screen menu of icons selected by highlighting and selecting, or on-screen menu of icons that are selected via a touch-screen interface.

In various implementations, system 110 may provide messages such as promotional messages alerting the user to an aspect of television 102 such as existing features or new features, an announcement of a new feature of the television platform (e.g., a new way to access applications or to navigate the settings menu). Such features enable the user to access a variety of media features, services, and products provided by system 110. A message may include information (e.g., a tip) for an existing feature (e.g., “Did you know that the Action Menu brings up a list of recently accessed programs?”). A message may include an advertisement for a service that the television platform can tune or deliver. As described in more detail herein, the system may display a message based at least in part on a button selection count based at least in part on predetermined time intervals. Such policies make messages less annoying and less objectionable. In other words, when a button is selected by the user, the television platform executes the operation associated with the button. The system may also implement some messaging depending on the button selection count or time interval between messages. For example, a promotional message may be delivered while the underlying function of the button is executed. This makes the messaging more tolerable to the user, because it does not occur with each and every selection of the button. For instance, if a user selects the home button for the seventh time, and as the icons are populated on screen, the system may present an audio message saying, “Check-out the Sony Privileged 4K service and get free 4K movies,” for example. The count or time interval would then reset. If the user then selects the home button an eighth time, then only the home function would execute.

In various implementations, system 110 may communicate with service provider 104 on behalf of television 102 in order to provide messages alerting the user to promotion programs, streaming services, etc. provided by service provider 104. Messages may also include television programs, television features, applications, and any other information for configuring and operating television 102. In various implementations, the system announces a variety of messages that are reconfigurable by a configuration file such as configuration file 114, which is accessible by system 110. For example, the text message or the audio generated from a text-to-speech engine may be delivered via a configuration file. Alternatively, in some implementations, the configuration file may provide uniform resource locators (URLs) to a video.

In some implementations, system 110 may be integrated with television 102, and may control television 102. In some alternative implementations, system 110 may also be separate from television 102, e.g., in a set-top box or an HDMI dongle, and still control what gets displayed on the television 102. In some implementations, system 110 may be integrated with a computer system that is separate from television 102. In some implementations, system 110 may be integrated with a server device in the cloud.

In various implementations, button 112 is associated with configuration file 114 that is accessible by system 110. In this particular example implementation, configuration file 114 is stored at system 110. In some embodiments, configuration file 114 may be stored remotely from system 110 and may be accessible by system 110. A configuration file is not required, but may provide added configurability. The button on the remote has a native function, e.g., the home button causes the home menu to display. The system may be configured such that when the home button is selected a certain number of times or after a certain amount of time as elapse, then messaging will delivered. As such, the system provides a message in an innocuous way, so that the message is not repeated too often as to be annoying. In some implementations, the messaging may be rendered while the home screen is being populated with icons.

As described in more detail herein, system 110 accesses configuration file 114 during an event (e.g., when a user selects button 112, etc.). Configuration file 114 may include information associated with one or more messages to present to a user. For example, configuration file 114 may include a message associated with one or more features of television 102, a message associated with one or more particular applications, a message associated with one or more particular services, etc. For ease of illustration, one configuration file 114 is shown. The number of configuration files may vary, and will depend on the particular implementation.

In some implementations, there may be multiple configuration files associated with multiple buttons 112. In some implementations, a given button may be associated with one or more configuration files. In such an example scenario, if the system detects the selection of the given button, the system may cause different messages from different respective configuration files to be displayed. In some implementations, a given configuration file may be associated with one or more buttons. In such an example scenario, if the system detects the selection of multiple buttons, the system may cause one or more different messages from one or more respective configuration files to be displayed for each selected button.

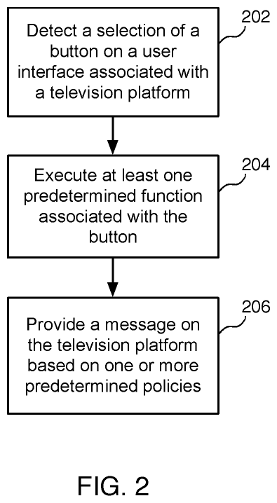

FIG. 2 is an example flow diagram for providing messages on a television platform, according to some implementations. Referring to both FIGS. 1 and 2, a method is initiated at block 202, where a system, such as system 110 detects a selection of a button on a user interface associated with a television platform. For example, the button may be an input button, a home button, an application button, etc. on a user interface of a remote control device such as remote control 108 or any other suitable device. In various implementations, the button may be an icon in a user interface menu navigated with a remote control or mouse. The button may also be an icon in a user interface menu on a touch screen interface such as on a personal computer, phone, or tablet. In some implementations, the button may be one of any number of buttons on a user interface, where the buttons are associated with multiple predetermined functions (e.g., home, launch application, channel up, channel down, volume up, volume down, etc.). Such predetermined functions may be reconfigurable. Other example functions are described in more detail herein.

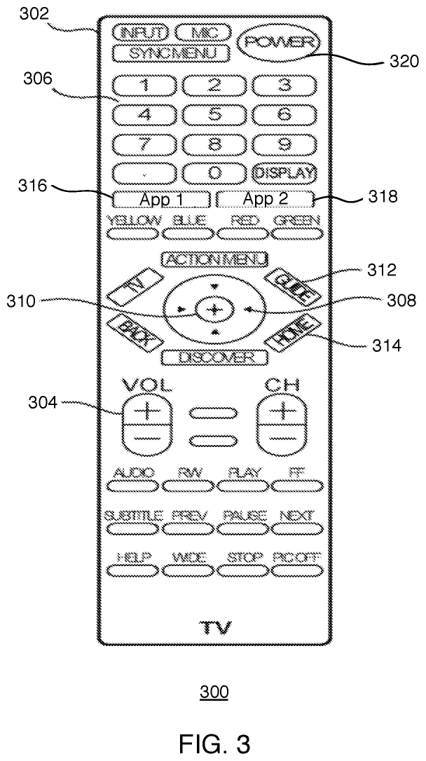

FIG. 3 is a block diagram of an example remote control device 300, according to some implementations. Remote control device 300, also referred to as remote control 300, may be used to implement remote control 108 of FIG. 1.

As described in more detail herein, the system presents various messages when the system detects a selection of a particular button on the remote control device. Messages may include promotions to existing television features, promotions to new television features, services and products including applications, etc. In various implementations, some television features, some products, and some services may become available when associated software (e.g., television software, system software, operating system software, application software, etc.) is downloaded or updated.

In various implementations, remote control 300 may include one or more internal processors, computer memories, and wireless transmitters such as IR command transmitters to control a device such as television 102 of FIG. 1.

As shown, remote control 300 includes a typically plastic, hand-holdable housing 302 with multiple input keys that can be manipulated by a person to cause wireless commands to be sent from the remote control 300 to television 102 (e.g., to system 110). Volume up and down keys 304 may be manipulated to respectively turn the volume of the speakers of television 102 up and down. An alpha-numeric keypad 306 may be provided on remote control 300 for inputting letters and/or numbers to television 102. Also, a directional input element such as a rocker 308 or directional keys may be provided with each arm of the rocker being manipulable to move a screen cursor up and down and left and right. If desired, a select key 310 may be located in the center of the rocker 308 for input of a “select” command.

Further, in the example shown, remote control 300 may include a guide key 312 manipulable to send a command to present an electronic program guide (EPG) on television 102. Also, a home key 314 may be provided and can be manipulated to invoke a home menu. A special accessibility key may be provided. As shown, many other keys also may be provided, making the task for a blind person to learn the functions of the keys less daunting.

In various implementations, remote control 300 may include a changeable label on a button 316 (labeled App 1), for example, where the label is associated with a television feature or application. In other embodiments, the button label may be fixed. In various implementations, the system may provide changeable labels on multiple buttons such as button 318 (labeled App 2), for example. In some implementations, various labels are possible, depending on the particular implementation.

At block 204, the system executes at least one predetermined function associated with the button. In various implementations, the button may trigger various predetermined functions, including the selection and launch of a menu, an application, and/or content. The particular predetermined function may vary, and will depend on the particular implementation. For example, the button may be associated with any of the following example functions: home, hub, settings, applications, back, last, guide, over-the-air TV, play, pause, fast forward, stop, input, select, up arrow, down arrow, left arrow, right arrow, red, green, blue, yellow, closed captioning, and many more. The button may be an icon for a service, e.g., Sony PlayStation Vue, etc. The button may also be specific content such as a movie or show. As indicated herein, the button may be a physical button on a remote control, or a soft button, e.g., icon, in a menu display that is first highlighted and then selected, or a touch screen icon that is selected. In each case, the selection of a button usually means that the TV platform is in some type of visual transition initiated by the user. As such, the user is present and has an opportunity to view messaging.

In some implementations, the system may provide some messages based at least in part on a configuration file. For example, in some implementations, the system may access a configuration file based at least in part on the selection of the button. In various implementations, the configuration file is associated with the button. There may be different configuration files associated with different buttons. For example, in some implementations, the system may access a configuration button when the user selects the power key such as button 320 to turn on the television. In some implementations, the system may access a configuration button when the user selects the home key such as home button 314 to navigate to a main menu of the television. The particular button to which a given configuration file is associated will vary, depending on the particular implementation. For example, in some implementations, the system may access a configuration button when the user selects an application button such as App1 button 316 or App2 button 318. In some implementations, button 318 may be any button found on a remote control, menu icon or touch screen interface icon of the television platform. For example, the button may be a home button. The button may trigger operations involving providing a message based on a predetermined count value (e.g., every 10^{th} time a button is pressed, etc.), and/or based on time intervals (e.g., if the home button is pressed after 1 day has passed, etc.). The configuration file may consist of text to message the user. In some implementations, text-to-speech may be used to provide audio messaging. In some implementations, the configuration file may provide links to audio and video files over the Internet. Regardless of whether or not a configuration file is used, the messaging is intermittent.

At block 206, the system provides a message on the television platform based on one or more predetermined policies. In various implementations, the system provides messages alerting the user to promotion programs, streaming services, etc. Messages may include announcements of one or more movies and/or television programs and/or applications. Messages may include announcements of one or more new television features and/or existing television features. Messages may include one or more tips associated with one or more new television features. Messages may include one or more tips associated with one or more existing television features. Messages may include other information for configuring and operating television 102. In various implementations, messages may include one or more advertisements. For example, in some implementations, a message may include an advertisement for one or more services. In some implementations, a message may include an advertisement for one or more shows.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

In some implementations, the system causes the message to be displayed for the user to view based on one or more predetermined policies. In some implementations, a predetermined policy may be for the system to provide the message based at least in part on a predetermined time interval. For example, the system may provide a message predetermined time intervals between announcements. In some implementations, the system may provide a particular message every 12 hours, 24 hours, every 48 hours etc., for example. In some implementations, a predetermined policy may be for the system to provide the message based at least in part on a predetermined button selection count. For example, in some implementations, the system may provide a message after every N clicks (e.g., 10 clicks, 30 clicks, 50 clicks, 75 clicks, etc.) of a particular button (e.g., home button, application button, menu, or touch-screen interface, etc.), upon boot-up (e.g., once on power off or re-setting of the television, etc.). The particular predetermined button selection count may be reconfigured and thus may vary, depending on the particular implementation.

In some implementations, a predetermined policy may be for the message to be displayed on the television screen for a predetermined time period (e.g., 5 seconds, 10 seconds, etc.) based at least in part on the type of button selected. For example, if the power button is selected, the system may cause a message to be displayed for a longer time period (e.g., 10 seconds, 15 seconds, etc.). A longer time period may be appropriate, where the user has just turned on the television and is settling in to relax and watch television. The user may be more receptive to looking at viewing options and/or television features. As such, a message associated the power button may be new television programs that are available, applications that are available, new television features available to the user, existing television features that the user has used seldom or has not used at all, etc. In another example, a longer time period may be appropriate where the user is channel surfing and/or just finished watching a television program or movie, and is in the mood for further entertainment.

In another example, a shorter time period may be appropriate for some buttons. For example, the user may be less receptive to looking at viewing options and/or television features after having selected an application button. The user at the time may be interested in using the application associated with the button selected and not interested in other options (e.g., other applications associated with buttons that were not selected, etc.).

In some implementations, a predetermined policy may be for the message to be displayed on the television screen for a predetermined time period (e.g., 5 seconds, 10 seconds, etc.) based at least in part on the command associated with the button associated with a configuration file. For example, the system may cause one or more messages to be displayed if the command is to launch an application, and may cause such messages to be displayed as long as a given application is in the process of being launched. As such, the system may discontinue displaying a message once the launch of the application is completed.

The system may provide services and/or products and/or television features directly or may obtain such services, products, and/or television features directly via a service provider such as service provider 104, for example. If a service, a product, and/or a feature is already installed on the system, the system may provide the product, and/or feature as appropriate (e.g., in response the user selecting an appropriate button, etc.). If a particular application is not already installed on the system, the system may fetch, download, and then launch the application in response the user selecting an appropriate button.

In various implementations, system 110 may communicate with service provider 104 on behalf of television 102 in order to retrieve television programs, television features, applications, and any other information for configuring and operating television 102. In some implementations, during the installation, the system may require the user to accept the granting of permissions to the app. Various example implementations directed to operations associated with button 112 and configuration file 114 are described in detail herein.

In some implementations, the system may provide audible messages in addition to or in lieu of visual messages, which may be preferred by some users. The system may enable a user to reconfigure a given configuration to select a preference for visual messages, audible messages, or both. In some implementations, the system may enable a user to turn off the message feature.

In some implementations, a predetermined policy may be for the system to provide one or more messages when there is an available upgrade to particular software, services, products, and/or features associated with the television.

Implementations described herein provide various benefits. For example, implementations facilitate a user in being aware of offered features, services, and products associated with his or her television. Implementations convey information and promotional material to users that should be missed and yet conveys the information in a non-obtrusive way and without having the user take extra actions to receive a promotional message.

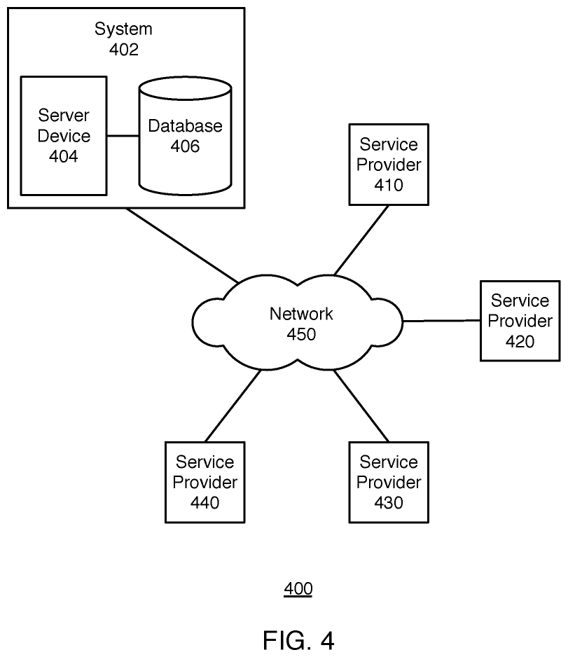

FIG. 4 is a block diagram of an example network environment 400, which may be used for implementations described herein. In some implementations, network environment 400 includes a system 402, which includes a server device 404 and a database 406. System 402 may be used to implement system 110 of FIG. 1.

Network environment 400 also includes service providers 410, 420, 430, and 440, which may communicate with system 402 and/or may communicate with each other directly or via system 402. Network environment 400 also includes a network 450 through which system 402 and service providers 410, 420, 430, and 440 communicate. Network 450 may be any suitable communication network such as a Wi-Fi network, Bluetooth network, the Internet, etc. In various implementations, system 402 may be used to implement embodiments described herein.

For ease of illustration, FIG. 4 shows one block for each of system 402, server device 404, and database 406, and shows four blocks for service providers 410, 420, 430, and 440. Blocks 402, 404, and 406 may represent multiple systems, server devices, and databases. Also, there may be any number of client devices. In other implementations, network environment 400 may not have all of the components shown and/or may have other elements including other types of elements instead of, or in addition to, those shown herein.

While server 404 of system 402 performs embodiments described herein, in other embodiments, any suitable component or combination of components associated with server device 404 or any suitable processor or processors associated with server device 404 may facilitate performing the embodiments described herein.

Implementations may apply to any network system and/or may apply locally for an individual system or device. For example, implementations described herein may be implemented by system 402 and/or any service providers 410, 420, 430, and 440. System 402 may perform the implementations described herein on a stand-alone computer, tablet computer, smartphone, etc. System 402 and/or any of service providers 410, 420, 430, and 440 may perform implementations described herein individually or in combination with other devices.

In the various implementations described herein, a processor of system 402 and/or a processor of any service providers 410, 420, 430, and 440 causes the elements described herein (e.g., information, etc.) to be displayed in a user interface on one or more display screens.

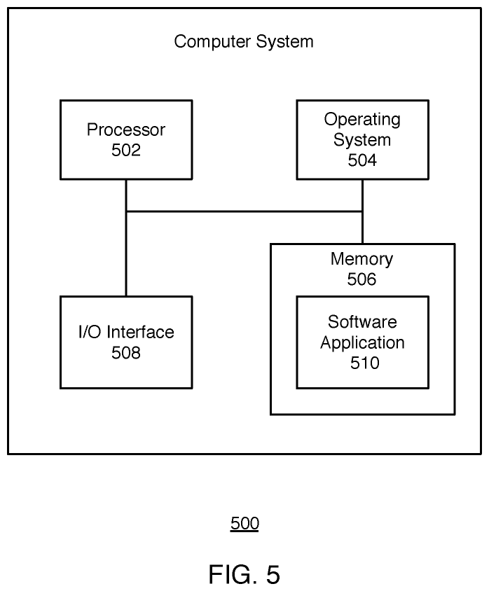

FIG. 5 is a block diagram of an example computer system 500, which may be used for some implementations described herein. For example, computer system 500 may be used to implement system 110 of FIG. 1, as well as to perform implementations described herein. In some implementations, computer system 500 may include a processor 502, an operating system 504, a memory 506, and an input/output (I/O) interface 508. In various implementations, processor 502 may be used to implement various functions and features described herein, as well as to perform the method implementations described herein. While processor 502 is described as performing implementations described herein, any suitable component or combination of components of computer system 500 or any suitable processor or processors associated with computer system 500 or any suitable system may perform the steps described. Implementations described herein may be carried out on a user device, on a server, or a combination of both.

Computer system 500 also includes a software application 510, which may be stored on memory 506 or on any other suitable storage location or computer-readable medium. Software application 510 provides instructions that enable processor 502 to perform the implementations described herein and other functions. Software application may also include an engine such as a network engine for performing various functions associated with one or more networks and network communications. The components of computer system 500 may be implemented by one or more processors or any combination of hardware devices, as well as any combination of hardware, software, firmware, etc.

For ease of illustration, FIG. 5 shows one block for each of processor 502, operating system 504, memory 506, I/O interface 508, and software application 510. These blocks 502, 504, 506, 508, and 510 may represent multiple processors, operating systems, memories, I/O interfaces, and software applications. In various implementations, computer system 500 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
detecting a selection of a button on a user interface associated with a television platform;
executing at least one predetermined function associated with the button; and
providing a message on the television platform based on one or more predetermined policies, wherein at least one policy of the one or more predetermined policies comprises providing the message based a predetermined time interval.

2. The system of claim 1, wherein the button is one of a plurality of buttons on the user interface, and wherein the plurality of buttons are associated with a plurality of predetermined functions.

3. The system of claim 1, wherein the providing of the message is based at least in part on a configuration file.

4. The system of claim 1, wherein the message comprises an announcement of one of a new feature or information for an existing feature.

5. The system of claim 1, wherein the message comprises an advertisement for at least one of a service or a show.

6. The system of claim 1, wherein the message comprises one or more of text, audio, and video.

7. The system of claim 1, wherein the logic when executed is further operable to cause the one or more processors to perform operations comprising providing the message based at least in part on a predetermined button selection count.

8. A non-transitory computer-readable storage medium with program instructions stored thereon, the program instructions when executed by one or more processors are operable to cause the one or more processors to perform operations comprising:
detecting a selection of a button on a user interface associated with a television platform;
executing at least one predetermined function associated with the button; and
providing a message on the television platform based on one or more predetermined policies, wherein at least one policy of the one or more predetermined policies comprises providing the message based a predetermined time interval.

9. The computer-readable storage medium of claim 8, wherein the button is one of a plurality of buttons on the user interface, and wherein the plurality of buttons are associated with a plurality of predetermined functions.

10. The computer-readable storage medium of claim 8, wherein the providing of the message is based at least in part on a configuration file.

11. The computer-readable storage medium of claim 8, wherein the message comprises an announcement of one of a new feature or information for an existing feature.

12. The computer-readable storage medium of claim 8, wherein the message comprises an advertisement for at least one of a service or a show.

13. The computer-readable storage medium of claim 8, wherein the message comprises one or more of text, audio, and video.

14. The computer-readable storage medium of claim 8, wherein the instructions when executed are further operable to cause the one or more processors to perform operations comprising providing the message based at least in part on a predetermined button selection count.

15. A computer-implemented method comprising:
detecting a selection of a button on a user interface associated with a television platform;
executing at least one predetermined function associated with the button; and
providing a message on the television platform based on one or more predetermined policies, wherein at least one policy of the one or more predetermined policies comprises providing the message based a predetermined time interval.

16. The method of claim 15, wherein the button is one of a plurality of buttons on the user interface, and wherein the plurality of buttons are associated with a plurality of predetermined functions.

17. The method of claim 15, wherein the providing of the message is based at least in part on a configuration file.

18. The method of claim 15, wherein the message comprises an announcement of one of a new feature or information for an existing feature.

19. The method of claim 15, wherein the message comprises an advertisement for at least one of a service or a show.

20. The method of claim 15, wherein the message comprises one or more of text, audio, and video.
